(19) United States
(12) Patent Application Publication
(10) Pub. No.: US 2010/0165428 A1
(43) Pub. Date: Jul. 1, 2010

(54) Device for Minimizing Diffraction-Related Dispersion in Spatial Light Modulators

(75) Inventor: Ralf Haussler, Dresden (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A., Munsbach (LU)

(21) Appl. No.: 12/529,557

(22) PCT Filed: Feb. 28, 2008
(86) PCT No.: PCT/EP2008/052408

§ 371 Date: Feb. 5, 2010

(30) Foreign Application Priority Data
Mar. 2, 2007 (DE) 102007011560.3

(51) Int. Cl. G03H 1/08

(52) U.S. Cl. 359/9

(57) ABSTRACT

A device for minimizing diffraction-related dispersion in spatial light modulators for holographically reconstructing colored representations is disclosed, and comprises a spatial light modulator designed as a diffractive optical element and provided with controllable structures, and at least one light source illuminating the spatial light modulator. Wavelength-dependent visible ranges associated with a predefined higher order of diffraction have a lateral chromatic offset relative to the position of the extensions of said visible ranges at a defined viewer's level, said lateral chromatic offset being in relation to the normal line to the surface of the spatial light modulator. The quality of reconstruction is improved regardless of the direction of incidence and emergence of the light.

This invention relates to a device for the minimisation of diffraction-related dispersion in light modulators for the holographic reconstruction of colour scenes, comprising a light modulator in the form of a diffractive optical element with controllable structures, and at least one light source for the illumination of the light modulator, where corresponding wavelength-dependent visibility regions related to a given higher diffraction order exhibit a lateral chromatic offset V, related to the surface normal of the light modulator, as regards the position of the dimensions BF_{R}, BF_{B}, BF_{B} of these visibility regions in a given observer plane. The invention relates to both amplitude modulators and phase modulators.

Spatial light modulators (SLM), for example being realised on the basis of liquid crystals, are areal optical elements which reflect or transmit visible light and whose optical properties can be temporarily modified by applying an electric field. The electric field can be controlled discretely for small surface areas, also referred to as pixels, which allows the optical transparency properties of the light modulator to be modified both pixel-wise and fine enough for many holographic applications. Advantage is taken of this possibility for example in order to modify, i.e. to modulate, an incident wave front during its passage through the light modulator such that, at the observer's distance, it resembles a wave front which is emitted by a real object. If the light modulator is controlled accordingly, a holographic reconstruction of a spatial object becomes possible without the need that this object is actually present at the time of its observation.

Document U.S. Pat. No. 6,922,273 for example describes the use of controllable electro-mechanical diffractive structures in the form of microelectrical mechanical structures (MEMS) as light modulators, where the light-modulating MEMS create different diffraction angles depending on the wavelength of the incident light. However, one of the drawbacks of these structures is that they diffract the light in only one direction. This is why two-dimensional transmissive or reflective light modulators on the basis of liquid crystals (LC) are most commonly used today.

Various types of amplitude-modulating light modulators based on the LC technology are known and widely used in two-dimensional (2D) display devices. In accordance with their actual application, they are already optimised to serve a large wavelength range and a large viewing angle range.

The dependence of the transmittance of amplitude-modulating light modulators based on the LC technology on the wavelength is compensated by way of a calibration at different wavelengths (red R, green G, blue B). In order to achieve a desired intensity at R, G or B, different voltages must be supplied to the liquid crystal cell for R, G and B.

The dependence of the transmittance on the viewing angle is compensated in liquid crystal modulators e.g. with the help of special compensation films, which are disposed in front of and/or behind the active liquid crystal layer.

It is further known that there are both diffractive optical elements (DOE) and refractive optical elements (ROE), where a chromatic dispersion occurs in both, diffractive optical elements and refractive optical elements, i.e. the diffraction or refraction angle changes as the wavelength of the incident light varies. Diffractive dispersion is an inherent feature of diffractive optical elements and thus always occurs without exceptions. Refractive dispersion is caused by the dependence of the refractive index of the material used on the wavelength.

When visualising three-dimensional scenes, which are e.g. encoded on a light modulator, it is always tried to make viewing possible in a large visibility region.

The observer therefore also perceives light which is transmitted at the light modulator at an oblique angle. Because holographic reconstructions are also generated in colour, dispersion effects at the light modulator cannot be excluded, which cause an offset of the individual colour components when reconstructing colour scenes, which can be very disturbing.

The dependence of a amplitude-modulating light modulator based on the LC technology on transmission angle and wavelength is already compensated as described above or can be compensated in a known manner. The diffractive dispersion, i.e. the different deflection of the individual wavelength portions of a ray of light, however, is extremely disturbing when using the light modulator as a diffractive optical element, e.g. in holography. The diffractive dispersion of a light modulator is particularly disturbing if for encoding a hologram e.g. on an amplitude modulator a detour phase encoding method such as the Burckhardt encoding method is used, because then the reconstruction does not take place in the zeroth diffraction order, but in the first diffraction order, and the light which is directed at the observer always exits the light modulator at an oblique angle. Because of this diffractive dispersion, the holographic reconstructions at different wavelengths are offset against one another.

This becomes particularly problematic if the diffraction angle is small because of a relatively large pixel pitch, as is commonly found in commercially available light modulators, and if in holographic reconstructions the visibility region is limited to one diffraction order of a hologram, as is described for example in document WO 2004 044659. If a certain diffraction order is used for the reconstruction, a limited visibility region is represented by a virtual window in the observer plane, through which the observer views the holographic reconstruction of a scene, for example a three-dimensional object, in the space that stretches between the light modulator and observer plane. This becomes particularly important when considering the fact that a visual perception by an observer is always only possible at the position of his eyes, which is why the holographic reconstruction of the wave front of the object must fulfil the observer's expectations at least at that position. The corresponding visibility region is as large as a diffraction order and is centred around the first diffraction order in the case of the Burckhardt encoding method. If the visibility region is tracked to the observer, it can be reduced to the size of an eye pupil in order to reduce the required resolution of the light modulator to a minimum, which is desired technologically.

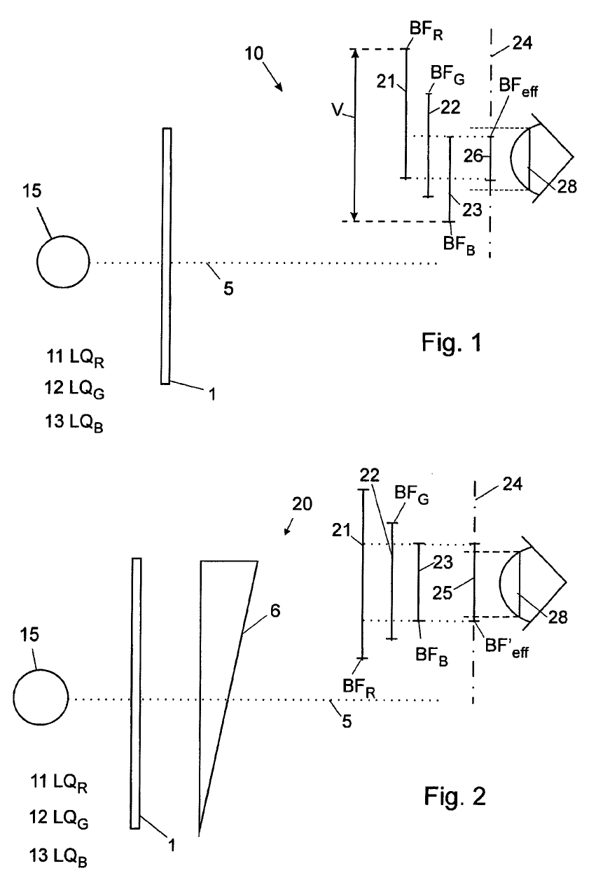

In FIG. 1, shows a conventional device for the generation of reconstructions with the help of a light modulator related to a visibility region and illustrates the problem that occurs in conjunction with a reconstruction of colour scenes, e.g. three-dimensional scenes, using a higher diffraction order, preferably the first diffraction order, with the example of a amplitude-modulating light modulator 1. The orientation of the light modulator 1 in space is defined by the surface normal 5. The light modulator 1 can represent a holographic display device, where for reasons of clarity for an illumination with a light source 15 only the individual light sources LQ_{R} 11 (light of the red wavelength range), LQ_{G} 12 (light of the green wavelength range), and LQ_{B} 13 (light of the blue wavelength range), the light modulator 1 and the visibility regions 21, 22, 23 with their dimensions BF_{R}, BF_{G}, BF_{B} are shown. The visibility regions 21, 22, 23 with BF_{R}, BF_{G}, BF_{B}, which are drawn in FIG. 1 behind one another at a distance, are situated in reality at the same distance from the light modulator 1 in an observer plane 24.

In the case of a colour reconstruction, where the light modulator 1 is illuminated with light of different wavelengths by light sources 11, 12, 13, which are located at the same position, the corresponding wavelength-dependent visibility regions 21, 22, 23 with BF_{R}, BF_{G}, BF_{B} have different dimensions and exhibit a chromatic offset V, which can also be referred to as a diffractive chromatic error, where on the other hand the respective wavelength-dependent dimension is only little larger than the size of the pupil 28 of an observer. The mutual displacement of the visibility regions 21, 22, 23 caused by the chromatic offset reduces the size of the possible visibility region to an effectively available visibility region 26 in the overlapping region, with a much smaller dimension BF_{eff} compared with the total sizes of the individual visibility regions 21, 22, 23. Consequently, only the region where BF_{R}, BF_{G}, BF_{B} overlap, which is—due to their chromatic offset V—substantially smaller than the regions BF_{R}, BF_{G}, BF_{B} themselves, can be used as the effective visibility region 26 with BF_{eff}, where the effective visibility region 26 with BF_{eff} can for example be smaller than the pupil 28 of an observer. Because much information may be lost during the visualisation of the reconstruction, the reconstruction quality gets worse in particular when looking at the display device at an oblique angle.

In document US 2006033972, this problem is solved by disposing the light sources of the different colours, LQ_{R}, LQ_{G}, LQ_{B}, at such mutual distance that the diffraction orders for the three colours overlap at the same position after diffraction at the structures of the light modulator. However, this is not possible if the individual colours originate in the same light source, i.e. if a white light source is used or if the colour light sources are disposed at fixed mutual distances, e.g. as is the case with the RGB pixels when using a colour display panel as a light source.

A device for holographic reconstruction of three-dimensional scenes is described in document WO 2006/119920, whereas the device comprises a system of focusing elements—a lens system, which directs coherent light from light sources to an observer window. A light modulator encoded with holographic information is situated between the system of focusing elements and the observer window. The device has a plurality of light sources for the illumination of the encoding area of the light modulator, whereas to each light source is assigned a focusing element. The light sources emit coherent light in such a way, that each of these light sources illuminates a predetermined encoding field on the encoding area, whereas the focusing element and the light source are arranged in such a way, that the light emitted by every the light source is directed accordingly to the observer window.

A problem arises from the great effort, which is necessary to adjust the system of focusing elements and its parameters regarding to the light sources and to the encoding fields of the light modulator, which are separated from one another.

It is therefore the object of this invention to provide a device for the minimisation of diffraction-related dispersion in light modulators for the holographic reconstruction of colour scenes, which is preferably designed such that during the holographic reconstruction of coloured three-dimensional objects the reconstruction quality is improved independent of the directions of light incidence or exit. Moreover, the effort necessary to adjust the involved elements for improving the reconstruction quality must be reduced.

The object of this invention is solved with the help of the features of claim no. 1.

The device for the minimisation of diffraction-related dispersion in light modulators for the holographic reconstruction of colour scenes comprises a light modulator in the form of a diffractive optical element with controllable structures, and at least one light source for the illumination of the light modulator, where corresponding wavelength-dependent visibility regions related to a given higher diffraction order exhibit a lateral chromatic offset V, related to the surface normal of the light modulator, as regards the position of the dimensions BF_{R}, BF_{B}, BF_{B} of these regions in a given observer plane.

where according to the characterising clause of claim no. 1
the light modulator is combined with at least one refractive optical element whose refractive chromatic dispersion |dδ/dλ| equals the diffractive chromatic dispersion |dθ/dλ| of the pixel-based light modulator, given according to the equation (VI)

|dδ/dλ|=|dθ/dλ| (VI)

where the refractive optical element exhibits such refractive chromatic dispersion |dδ/dλ| with an opposing effective direction that the wavelength-dependent visibility regions with their dimensions BF_{R}, BF_{B}, BF_{B} are centred on an effective visibility region with a dimension BF′_{eff} in the specified observer plane, where δ is the deflection angle of the refractive optical element, θ is the diffraction angle and λ is the wavelength.

The light source can be a single white light source, which contains the three wavelengths of red, green and blue.

The light source can alternatively be a light source unit with the light sources of the individual colours LQ_{R}, LQ_{G}, LQ_{B} with the wavelengths blue, green, red, which are optionally disposed at the same position or at various positions in a plane which is preferably arranged at a right angle to the surface normal. The dimension BF′_{eff} of the common effective visibility region can be the same as the dimension BF_{B} of the visibility region for the blue wavelength.

The light modulator can have an optically active layer, preferably in the form of a plane birefringent layer, which contains liquid crystals, and whose refractive index ellipsoid is controllable by applying an electric field to the structures in the form of pixels. An optically active layer shall be understood to be an at least partly transmissive and/or reflective layer whose optical volume properties depend on at least one externally adjustable physical parameter and which can be influenced in a controlled manner by varying that parameter.

The light modulator can alternatively comprise controllable electromechanical structures—MEMS—with diffractive optical properties which make the light modulator a diffractive optical element.

A preferably triangular prism can be arranged as a refractive optical element, said prism comprising two interfaces and one flanking face, where the two interfaces form the sides of the prism angle α which is situated opposite the flanking face.

The corresponding prism angle α is therein inversely proportional to the distance p (pitch) between the centres of two adjoining pixels of the light modulator.

Instead of a single prism, the refractive optical element can be a prism grid which comprises multiple prisms or periodically arranged sectors of prisms.

The prisms of the prism grid can have a base length b of the interface which is adjacent to the light modulator, where the base length b can be equal to or an integer multiple of the pitch p of the pixels of the light modulator.

The prisms of the prism grid can each have an undercut flanking face.

The undercut flanking faces can have a flanking angle β, i.e. the angle between a plane which is parallel to the interface and the flanking faces of the prisms, which run at oblique angles so to form the undercut. The flanking angle β equals the angle of 90°, which represents the direction of the surface normal, minus the diffraction angle θ in the given diffraction order.

If the invention is realised in the form of a light modulator for holographic display devices which comprises at least one optically active layer whose refractive index ellipsoid can be controlled discretely for each pixel, there is—according to this invention—thus at least one refractive compensation element which counteracts the diffractive dispersion caused by the pixel-based structure of the optically active layer.

In particular if the light modulator is used at viewing angles at which dispersion effects are disturbing, it is thus sensible for an achromatic compensation, by which the refractive optical element, which counteracts the diffractive dispersion of the optically active layer of the light modulator, is combined with the optically active layer. The shown prism or the shown prism grids represent such a refractive optical element, for example.

The dependence of the reconstruction on the wavelength, in particular when using a amplitude-modulating light modulator, can thus be compensated for example by disposing a prism or a shown prism grid near the light modulator.

However, a prism is an asymmetrical optical element. The asymmetry can be utilised if the light modulator is used such that it is viewed at an oblique angle and always at the same orientation. This is achieved for example if a higher diffraction order than the zeroth diffraction order is selected for the holographic reconstruction of a colour scene. In particular in holographic applications where higher diffraction orders are used for the reconstruction of scenes to be viewed, uncompensated dispersion effects are disturbing.

In order to minimise diffraction-related dispersion, the dispersion of the refractive index and the prism angle α of the prism are chosen such that the dispersion of the prism and the dispersion of the optically active layer or of the controllable electromechanical structures of the light modulator have the same absolute value, but opposing effective directions. However, in practice this can not in all cases be realised with the required precision. Nevertheless, the invention already leads to a noticeable improvement in the quality of the optical reconstruction if the refractive optical element is designed such that it corrects at least 80% of the diffractive dispersion of the light modulator, or if the prism or the prism grid are designed such that after calculation of the corresponding prism angle α the remaining diffractive dispersion of the device becomes minimum.

Generally, the device according to this invention can be applied to both amplitude modulators and phase modulators, which are used for the holographic reconstruction of a colour scene in a diffraction order other than the zeroth one.

In order to be able to use conventional light modulators, e.g. on the basis of liquid crystals, and to improve them by means of a refractive optical compensation element, it is sensible to use a separate compensation element and to dispose it outside the optically active layer but at a distance to the optically active layer which is as small as possible, because a ray of light which is transmitted through the light modulator and which comprises multiple colour components LQ_{R}, LQ_{G}, LQ_{B}, exits the optically active layer in the form of a divergent bundle of rays. The distance between the individual rays of different colour thus rises as the distance between the refractive optical element and the optically active layer increases, which makes difficult a compensation of the diffraction-related divergence at a greater distance from the optically active layer.

In particular if prisms are used as refractive compensation elements, it will be sensible if the refractive optical element comprises multiple prisms or periodically arranged sectors of prisms in the form of a prism grid, in order to save volume and weight and to prevent the occurrence of parallactic effects, which would occur with glass elements of greater thickness. If the refractive optical prism grid comprises multiple prisms or sectors of prisms whose base length b is equal to or an integer multiple of the pitch p of the pixels of the light modulator, diffraction at the edges of the elements can be reduced to a minimum.

In particular with small base lengths of the prisms in such multiple arrangements of prisms, it is advantageous if the flanking faces of the prisms in the region of the greatest distance of the optically effective interfaces are about parallel to the rays of light which pass through the prisms. This way, the size of regions which do not have a prismatic effect when the light modulator is looked at under an oblique angle is at least reduced. By undercutting the individual prisms, almost the entire surface area of the prism arrays is at least at a certain viewing angle a surface which counteracts the diffractive dispersion of the light modulator, because almost all rays of light pass both optically effective interfaces before they reach the observer plane.

The present invention is described in more detail below with the help of a number of embodiments and drawings, wherein

FIG. 1 is a schematic view showing a prior art device for the visualisation of reconstructions of colour scenes in a visibility region using a higher diffraction order other than the zeroth one on a amplitude-modulating light modulator with diffractive dispersion.

FIG. 2 is a schematic view showing an inventive device for the minimisation of diffraction-related dispersion in light modulators during reconstructions of colour scenes in a visibility region using a higher diffraction order on a amplitude-modulating light modulator, where the diffractive dispersion shown in FIG. 1 is largely compensated with the help of a refractive compensation element in the form of a prism.

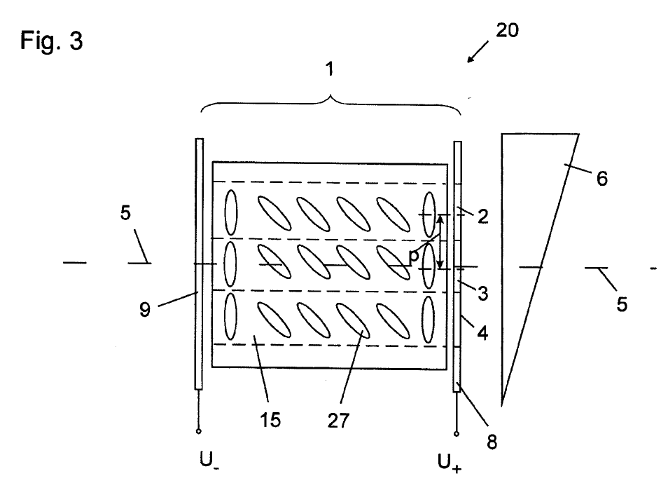

FIG. 3 is a schematic view showing a diffractive light modulator based on liquid crystals and a refractive prism as major components of the device according to the invention.

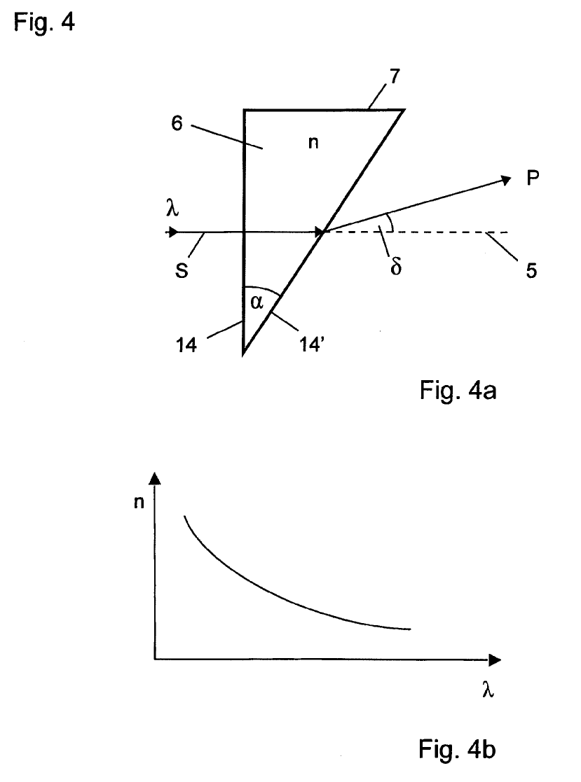

FIG. 4 is a schematic view showing the prism according to FIG. 3, where FIG. 4a shows an optical path through the prism, and

FIG. 4b shows the corresponding refractive index (n)-wavelength (λ) characteristic.

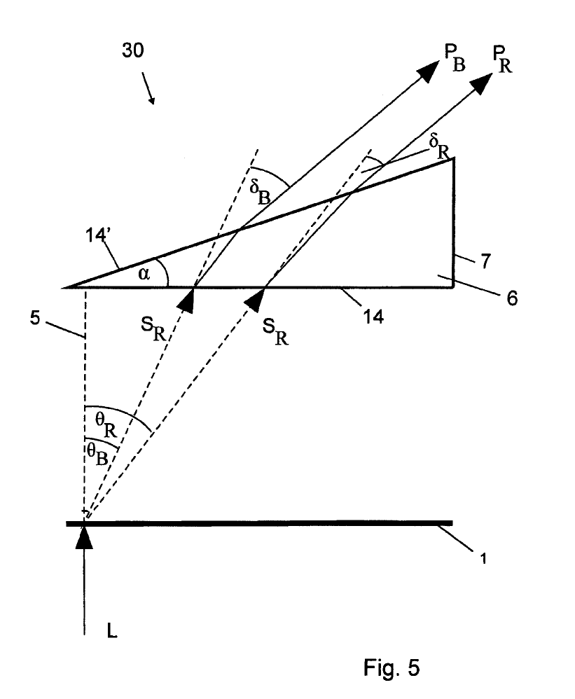

FIG. 5 is a schematic view showing rays of light which are transmitted through a diffractive light modulator and which are then deflected in a wavelength-specific manner by the refractive prism disposed behind the light modulator.

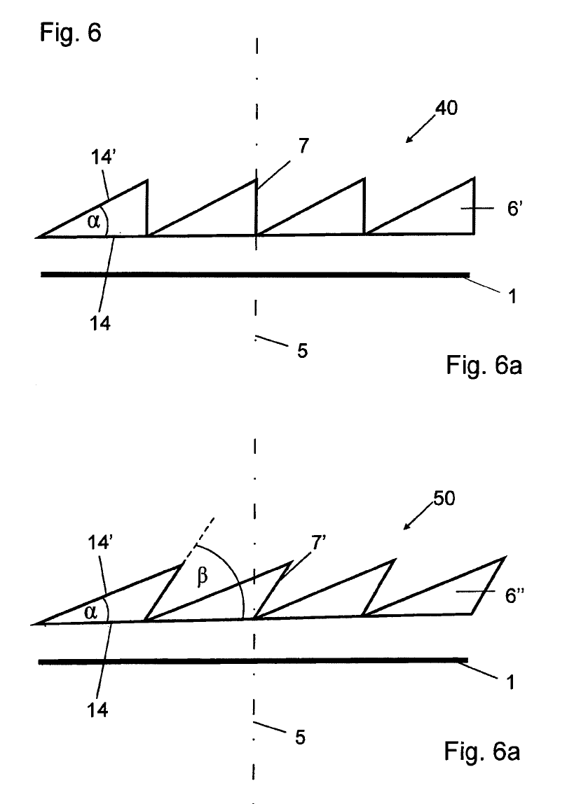

FIG. 6 is a schematic view showing the device according to this invention, where

FIG. 6a shows a diffractive light modulator with a first refractive prism grid, and

FIG. 6b shows a diffractive light modulator with a second refractive prism grid.

FIG. 2 is a schematic diagram showing an inventive device 20 for the minimisation of diffraction-related dispersion in the light modulator 1, whose pixels can be discretely encoded, for a reconstruction of colour scenes with oblique visualisation, and wavelength-specific visibility regions which are assigned to the first diffraction order of the reconstructed wave front, where according to this invention at least one refractive optical element 6 in the form of a prism is disposed between the light modulator 1 as a diffractive optical element and the wavelength-specific visibility regions 21, 22, 23 with their respective dimensions BF_{R}, BF_{G}, BF_{B}, in order to largely compensate the chromatic dispersion of the light modulator 1.

The orientation of the light modulator 1 in space is defined by the surface normal 5. The light modulator 1 can represent a holographic display device, where for reasons of clarity only one light source 15 with the individual light source colour components LQ_{R} 11 (light of the red wavelength range), LQ_{G} 12 (light of the green wavelength range), and LQ_{B} 13 (light of the blue wavelength range), the light modulator 1 and the visibility regions 21, 22, 23 (21 for the red wavelength portion, 22 for the green wavelength portion, and 23 for the blue wavelength portion) with their dimensions BF_{R}, BF_{G}, BF_{B} are shown. The visibility regions 21, 22, 23, which are drawn in FIG. 1 behind one another at a distance, are situated in reality at the same distance from the light modulator 1 in an observer plane 24.

During the holographic reconstruction of colour scenes, when the light modulator 1 is illuminated with light emitted by the light source 15 which comprises the light source components 11, 12 and 13 with different wavelengths, the corresponding wavelength-specific visibility regions 21, 22, 23 still differ in their dimensions BF_{R}, BF_{G}, BF_{B}, which correspond with the individual chromatic errors, but they do not exhibit any lateral offset V because the refractive prism 6 is arranged such that it cancels out the diffraction of the light modulator 1. Thanks to the matched centring of the visibility regions 21, 22, 23 with their respective dimensions BF_{R}, BF_{G}, BF_{B} in the observer plane 24, a compensating overlapping is achieved which in conjunction with the centring creates an increased effective visibility region 25, which has a greater dimension BF′_{eff} than the effective visibility region 26, which corresponds to the uncompensated overlapping, with the dimension BF_{eff}, as shown in FIG. 1. According to this invention, the observer is provided an enlarged effective visibility region 25 with the dimension BF′_{eff} for the visualisation of the reconstruction. The enlarged effective visibility region 25 with the dimension BF′_{eff} can be as large or even larger than the pupil 28 of the observer. Because then substantially more pieces of information contribute to the visualisation of the reconstruction of colour scenes compared with the conventional device 10, the perceivable information and the reconstruction quality are improved in particular when viewing at an oblique angle.

Referring to FIG. 2, the dimension BF′_{eff} of the common effective visibility region 25 can be the same as the dimension BF_{B} of the visibility region 23 for the blue wavelength.

Referring to FIG. 3, the diffractive light modulator 1 based on liquid crystals is reduced in this simplified version to three pixels 2, 3, 4, which are all assigned to an optically active layer 15, and which can be controlled with the help of electrodes 8, 9, which are disposed on the opposite, plane surfaces of the layer 15. The electrodes 8, 9 are structured such that a controllable electric field can be applied discretely for each pixel with the help of the modulation potential U₊ and the modulation potential U₋. The optically active layer 15 comprises birefringent material in the form of liquid crystals 27, whose orientation is illustrated with the help of corresponding refractive index ellipsoids. The orientation of the light modulator 1 is defined by the surface normal 5. The light modulator 1 is followed in the direction of light propagation by the refractive optical element in the form of a prism 6, which is designed such that the conventional diffractive dispersion of the light modulator 1 is largely compensated in the inventive device 20 in combination with the refractive prism 6.

FIG. 4 shows the refractive prism 6 according to FIG. 3, where FIG. 4a shows in a simplified manner an optical path through the prism 6, and FIG. 4b shows the corresponding refractive index (n)-wavelength (λ) characteristic of the prism 6. Now, the functional principle of the refractive optical prism 6 will be explained. As already shown in FIG. 3, the preferably triangular prism 6 comprises two interfaces 14, 14′ and one flanking face 7, where the two interfaces 14, 14′ form the sides of the prism angle α which is situated opposite the flanking face 7.

FIG. 4a illustrates that the prism 6, which is characterised by the prism angle α between the two interfaces 14, 14′, deflects a ray of light S, which hits the interface 14 at a right angle, i.e. parallel with the surface normal 5, and which has a wavelength λ, so that it exits the prism as the ray of light P at the deflection angle δ, where equation (I) applies:

δ=a sin(n·sin(α))−a (I),

where n is the refractive index of the prism 6. For small angles α and δ, equation (I) can be approximated as a linear relation. The approximation also applies if the ray of light S does not hit the interface 14 at a right angle, but at a small angle to the surface normal 5:

δ=(n−I)·a (II).

The refractive index n depends on the wavelength λ, as is illustrated in the refractive index (n)-wavelength (λ) characteristic shown in FIG. 4b. The deflection angle δ thus also depends on the wavelength λ. The differential dependence on the wavelength can be expressed as follows:

dδ/dλ=α·dn/dλ (III).

Equation (III) describes the refractive dispersion.

The diffraction angle θ of the light modulator 1 in the first diffraction order can be defined as follows:

θ=λ/p (IV),

where the pitch p is the distance between the centres of adjacent pixels 2, 3 and 3, 4 of the light modulator 1. The differential dependence of the diffraction angle θ on the wavelength, i.e. the diffractive dispersion of the light modulator 1, is expressed in equation (V):

dθ/dλ=1/p (V).

If the refractive index n in the given wavelength range shows a linear curve, do/dA in equation (II) is constant. This means that the diffractive dispersion will be fully compensated in the device 20, if the prism angle α is chosen such that the refractive dispersion dδ/dλ and the diffractive dispersion dθ/dλ in equation (VI) have the same absolute value:

|dδ/dλ=|dθ/dλ|=>α·|dn/dλ|=1/p (VI).

The prism angle α can be found by solving equation (VI), as expressed in equation (VII):

α=1/(p·|dn/dλ| (VII).

Moreover, the prism 6 with its interfaces 14, 14′ is disposed in relation to the light modulator 1 such that the refractive dispersion dδ/dλ of the prism 6 and the diffractive dispersion dθ/dλ of the light modulator 1 have opposing effective directions.

This has the result that the inherent dependence of the diffraction angle θ of the light modulator 1 on the wavelength is largely compensated by the refractive dispersion of the prism 6. The reconstructions which comprise several wavelengths, i.e. the visibility regions 21, 22, 23 with BF_{R}, BF_{B}, BF_{B} are thus located at the same, centred position and overlap so to form the effective visibility region 25 with BF′_{eff}, as shown in FIG. 2.

The dependence of the refractive index on the wavelength will usually only exhibit a linear curve in a small wavelength range. However, in the wavelength range of the visible light, i.e. in the range between approximately 400 nm and approximately 650 nm, a linear approximation is possible, so that dn/dλ is almost constant in this range. This means that although the diffractive dispersion cannot be fully compensated, it can at least be largely compensated.

The present invention can be adapted to the use of higher diffraction orders than the first diffraction order described above. However, due to the lower intensity of higher diffraction orders, only the first diffraction order is typically used.

FIG. 5 is a schematic view showing the device 30 according to this invention and an optical path, which illustrates in a simplified manner the light modulator 1 and the prism 6. The light modulator 1 is illuminated with sufficiently coherent light, where the ray of light L is transmitted through the light modulator 1. The ray of light L hits the light modulator 1 at a right angle. The orientation of the light modulator 1 in space is again defined by its surface normal 5. The light modulator 1 is an amplitude modulator, and for encoding a hologram a Burckhardt encoding method can be used, which represents a detour phase encoding method, where the pixels 2, 3, 4 of the light modulator 1 can be used in order to encode a complex transparency value of the hologram. The pixel pitch is p. The reconstruction of the colour scene, e.g. a three-dimensional scene, and the visibility region are situated in the first diffraction order. The first diffraction order has an angular width of λ/3p. Its centre is located at a diffraction order angle of λ/3p to the direction of the ray of light L.

Further, downstream the light modulator 1, seen in the direction of light propagation, a ray of light S_{B} for blue light is shown which is directed at the centre of the first diffraction order under a diffraction order angle to the incident ray of light L as defined in equation (VIII):

δ_{B}=λ_{B}/3p (VIII).

Likewise, a ray of light S_{R} for red light is shown which is directed at the centre of the first diffraction order under a diffraction angle to the incident ray of light L as defined in equation (IX):

δ_{R}=λ_{R}/3p (IX),

where λ_{B} and λ_{R} are the wavelengths of blue and red light, respectively. Further,

θ_{R}>θ_{B}, because λ_{R}>λ_{B} (X).

The rays of light P_{B} and P_{R}, which exit the prism 6 with its prism angle α, are deflected by another deflection angle δ_{B} and δ_{R}, related to the direction of the rays of light S_{B} and S_{R}, respectively. δ_{B} and δ_{R} are the deflection angles which occur after diffraction in the prism 6. They can be approximated for small angles as follows:

δ_{B}=(n_{B}−I)·αresp. δ_{R}=(n_{R}−I)·α (XI),

where n_{B} and n_{R} are the refractive indices for blue and red light, respectively. With only very few exceptions, the refractive index of a material decreases as the wavelength rises. Consequently,

δ_{B}>δ_{R}, because n_{B}>n_{R} (XII).

According to

α·|dn/dλ|=I/3p (XIII),

the dispersion of the light modulator 1 and the dispersion of the prism 6 cancel out each other.

It is herein considered that according to the Burckhardt encoding method three pixels are required in order to encode one complex number.

The derivatives of the equations (I) to (VII) and (VIII) to (XIII) for the two exemplary instances of the encoding show that the prism angles α are inversely proportional to the distance (pitch) p between the two centres of adjacent pixels 2, 3; 3, 4 of the light modulator 1.

Now, a dimensioned embodiment will be described. A light modulator 1 with a pitch of p=20 μm and a prism 6 of the high-dispersion glass type SF6 are used. The prism 6 is characterised by the refractive indices n_{B}=1.8297 and n_{R}=1.7975, and the corresponding wavelengths λ_{B}=486 nm and λ_{R}=656 nm. The approximation

dn/dλ≈(n_{B}−n_{R})/(λ_{B}−λ_{R})=−1.9·10⁻⁴ nm⁻¹

yields a prism angle α of 5.0°. The prism 6 is arranged such that the dispersion of the light modulator 1 and the dispersion of the prism 6 have opposing effective directions and thus cancel out each other.

In the entire wavelength range of between λ_{B} and λ_{R}, the dispersion of the light modulator 1 and the dispersion of the prism 6 are thus largely compensated. The exiting rays of light P_{B} and P_{R} have the same direction, which is why the scene is holographically reconstructed at the same position, and the visibility region 25 lies centred for different colours at the same position so that there are no limitations as regards the size of the effective visibility region 25 with BF′_{eff} caused by an inadequate overlapping.

The prism 6 can optionally cover the entire width of the light modulator 1.

Instead of a prism 6, an array of prisms, a so-called refractive prism grid, can be used, where each prism covers a section of the light modulator 1 which is wide enough to allow coherent reconstruction. Devices 40, 50 according to this invention with respective prism grids are shown in FIGS. 6, 6a and 6b.

FIG. 6a shows a simplified version of the device 40 according to this invention, comprising a light modulator 1 and a first prism grid 6′. The individual, periodically arranged prisms of the first prism grid 6′ each have the two interfaces 14, 14′ and the flanking face 7, which is situated opposite the prism angle α. The flanking face 7 is parallel to the surface normal 5 of the light modulator 1. The base length b of the prisms is preferably equal to the pitch p of the light modulator 1 or an integer multiple kp (with k=2 to m) of that pitch p. Apart from that, the same angular relations and accordingly derived equations apply as described with view to FIG. 5.

FIG. 6b shows the device 50 according to this invention, comprising the light modulator 1 and a second prism grid 6″. The difference to FIG. 6a is that the flanking faces 7′ of the prisms are designed differently. While the flanking faces 7 of the prisms of the prism grid 6′ in FIG. 6a are oriented parallel to the surface normal 5 of the interface 14, the flanking surfaces 7′ of the prisms of the second prism grid 6″ in FIG. 6b exhibit a flanking angle β to the surface normal 5. This way, the size of regions which do not have a prismatic effect when the light modulator 1 is looked at under an oblique angle is substantially reduced.

By undercutting the individual prisms of the prism grids 6′ and 6″, almost the entire surface area of the prism grids 6′ and 6″ acts at least at a certain viewing angle as an areal refractive dispersion element which counteracts the diffractive dispersion, because almost all rays of light pass both optically effective interfaces 14, 14′ of the prisms before they reach the visibility regions 21, 22, 23.

The compensation of the dependence of transmissive diffractive light modulators on the wavelength can be applied analogously to reflective diffractive light modulators and is not restricted to the liquid-crystal-type amplitude modulators which were used in the embodiment merely to illustrate the invention. Neither shall the invention be limited to the prisms used as refractive dispersion compensation elements.

### LIST OF REFERENCE NUMERALS

1 Light modulator
2 First pixel
3 Second pixel
4 Third pixel
5 Surface normal
6 Prism
6′ First prism grid
6″ Second prism grid
7 Flanking surface
7′ Flanking surface
8 First electrode
9 Second electrode
10 Prior art device
11 First light source colour component LQ_{R}
12 Second light source colour component LQ_{G}
13 Third light source colour component LQ_{B}
14 First interface
14′ Second interface
15 Optically active layer
20 Device
21 Red visibility region
22 Green visibility region
23 Blue visibility region
24 Observer plane
25 Centred effective visibility region
26 Prior art effective visibility region
27 Liquid crystal
28 Pupil
30 Device
40 Device
50 Device
BF Visibility region
BF_{eff} Dimension of the prior art effective visibility region
BF′_{eff} Dimension of the centred effective visibility region
BF_{R} Dimension of the red visibility region
BF_{G} Dimension of the green visibility region
BF_{B} Dimension of the blue visibility region
U₊ Modulation potential
U₋ Modulation potential
p Pitch
b Base
n Refractive index
λ Wavelength
α Prism angle
β Flanking angle
δ Deflection angle
θ Diffraction angle
S Ray of light
L Ray of light
P Ray of light

1. Device for the minimisation of diffraction-related dispersion in light modulators for the holographic reconstruction of colour scenes, comprising a light modulator in the form of a diffractive optical element with controllable structures, and at least one light source for the illumination of the light modulator, where corresponding wavelength-dependent visibility regions related to a given higher diffraction order exhibit a lateral chromatic offset, related to the surface normal of the light modulator, as regards the position of the dimensions of these visibility regions in a given observer plane wherein the light modulator is combined with at least one refractive optical element, whose refractive chromatic dispersion |dδ/dλ| is equal to the diffractive chromatic dispersion |dθ/dλ| of the pixel-based light modulator, according to the equation

|dδ/dλ|=|dθ/dλ|

where the refractive optical element exhibits such refractive chromatic dispersion |dδ/dλ| with an opposing effective direction that the wavelength-dependent visibility regions with their dimensions are centred on an effective visibility region with a dimension in the specified observer plane, where δ is the deflection angle of the refractive optical element, θ is the diffraction angle and λ is the wavelength.

2. Device according to claim 1, wherein the light source is a single white light source, which contains the three wavelengths of red, green and blue.

3. Device according to claim 1, wherein the light source is a light source unit with the light sources of the individual colours with the wavelengths of blue, green, red, which are disposed at the same position or at various positions in a plane which is arranged at a right angle to the surface normal.

4. Device according to claim 1, wherein the dimension of the common effective visibility region can be the same as the dimension of the visibility region for the blue wavelength.

5. Device according to claim 1 wherein the light modulator has an optically active layer, in the form of a plane birefringent layer, which contains liquid crystals, and whose refractive index ellipsoid is controllable by applying an electric field to the structures in the form of pixels.

6. Device according to claim 1, wherein the light modulator comprises controllable electromechanical structures with diffractive optical properties.

7. Device according to claim 1, wherein the refractive optical element is represented by at least one triangular prism, which comprises two interfaces and one flanking face, where the two interfaces form the sides of the prism angle which is situated opposite the flanking face.

8. Device according to claim 7, wherein the prism angle is inversely proportional to the distance between the centres of two adjacent pixels of the light modulator.

9. Device according to claim 1, wherein the refractive optical element is a prism grid which comprises multiple prisms or periodically arranged sectors of prisms.

10. Device according to claim 9, wherein the prisms of the prism grid have a base length which is equal to the pitch of the light modulator or an integer multiple of thereof.

11. Device according to claim 9 wherein the prisms of the prism grid have undercut flanking faces.

12. Device according to claim 11, wherein the undercut flanking faces have a flanking angle, i.e. the angle between a plane which is parallel to the interface and the flanking faces of the prisms, which run at oblique angles so to form the undercut, which equals the angle of 90°, which represents the direction of the surface normal, minus the diffraction angle in the given diffraction order.

13. Device according to claim 10, wherein the prisms of the prism grid have undercut flanking faces.

14. Device according to claim 13, wherein the undercut flanking faces have a flanking angle, i.e. the angle between a plane which is parallel to the interface and the flanking faces of the prisms, which run at oblique angles so to form the undercut, which equals the angle of 90°, which represents the direction of the surface normal, minus the diffraction angle in the given diffraction order.
